(19) United States
(12) Patent Application Publication
(10) Pub. No.: US 2013/0266253 A1
(43) Pub. Date: Oct. 10, 2013

(54) SYSTEM AND METHOD FOR SUBSTRATE THINNING IN ELECTRO-OPTICAL MODULATORS

(71) Applicant: Phase Sensitive Innovations, Inc., Newark, DE (US)

(72) Inventors: Julien Macario, Newark, DE (US); Peng Yao, Newark, DE (US); Dennis W. Prather, Newark, DE (US)

(21) Appl. No.: 13/623,384

(22) Filed: Sep. 20, 2012

Related U.S. Application Data
(60) Provisional application No. 61/537,373, filed on Sep. 21, 2011.

(51) Int. Cl. G02F 1/035; B23Q 3/08

(52) U.S. Cl. CPC G02F 1/035; B23Q 3/086
USPC 385/2; 29/557

(57) ABSTRACT

A method for manufacturing a modulator device is provided. The method includes providing an at least partially completed modulator having a top and a bottom and a substrate; fixedly mounting the top of the modulator on a mechanical support; removing from the bottom of the modulator a portion of the substrate, thereby forming a groove in the substrate; and separating the modulator with the groove from the mechanical support; wherein the reduced thickness of the substrate in the area of the groove restricts the flow of energy leakage into the substrate.

### CROSS REFERENCE TO RELATED APPLICATIONS

The instant application claims priority to U.S. Provisional Patent Application No. 61/537,373, entitled LITHIUM NIOBATE MICROMACHINING PROCESS filed on Sep. 21, 2011, and relates to co-pending U.S. patent application Ser. No. ______ entitled MILLIMETER-WAVE ELECTRO-OPTIC MODULATOR, filed on Sep. ______, 2012, the disclosures of which are incorporated herein by reference in its entirety.

### GOVERNMENT LICENSE RIGHTS

This invention was made with government support under Contract No. ______ (identify the contract) awarded by and by the Office of Naval Research-C4ISR Applications Division. The government has certain rights in the invention.

### BACKGROUND OF THE INVENTION

1. Field of the Invention

The present invention relates to electro-optical modulators. More specifically, the present invention relates to thinning the substrate of electro-optical modulators to a level that limits leakage of energy into the substrate.

2. Discussion of Background Information

Modulators are well known devices that change the physical properties of a signal. For example, electro-optical modulators convert electrical data signals into optical data signals by alternating the flow of light through the modulator based on the nature of the electrical data signals. Such electro-optical modulators are deployed in a variety of uses, such as fiber optic communications of data.

Referring now to FIG. 1, a prior art electro-optical modulator 100 is shown. Modulator 100 generally includes a substrate 102 and an electrode region 106. Embedded within substrate 102 proximate to a top thereof is an optical waveguide 104. Electrode region 102 is generally separated into two ground electrodes 108 and 110, and a center electrode 112. Electrode region 106 is typically made of gold, and substrate 102 is typically made from lithium niobate (“herein “LN”), although other materials are in known. FIG. 1 shows the thickness and width of modulator 100, with the length dimension extending into the page. A typical modulator is on the order of 2 cm in length, 1 mm in width, and 500 microns in thickness.

Application of voltage potential to the various electrodes induces an electrical field in the electrode region 106 from the flow of current. This electrical field in turn manipulates the optical characteristics of the waveguide 104 to thereby effect and control the nature of the passage of light there through. If the applied voltage is based on data signals, modulator 100 will in response adjust its light flow into corresponding light data signals for transmission.

A drawback of the prior art design is that during propagation of light through waveguide 104 (e.g., left to right in FIG. 1), energy can leak into substrate 102 (downward in FIG. 1). This phenomenon is often referred to as “substrate mode.” This energy leakage reduces the efficiency and the overall performance of modulator 100.

The amount of leakage is based in part on the thickness of the substrate 102. This is because energy can only propagate in the medium that is physically long enough to accommodate the wavelength of the energy. For example, for a substrate 102 in FIG. 1 of approximately 1 millimeter, energy with a frequency as low as about 20 GHz can leak into the substrate. If the signal of interest has a frequency below about 20 GHz, then the substrate 102 is not thick enough to permit energy leakage for that signal. However, if the signal of interest has a higher frequency, then the substrate 102 is thick enough for energy leakage.

A thinner substrate 102 of 500 microns has a higher threshold of about 60 GHz. The thinner substrate thus does not allow for energy leakage for signals with frequencies of the 20-60 GHz range to enter. This thinner substrate can be more efficient that its thicker counterpart if the signals of interest are below about 60 GHz.

In recent years, there has been an expansion of the use of modulators in millimeter-wave (herein “mmW”) imaging. These modulators work in the so called “W-band” of the microwave part of the electromagnetic spectrum, which ranges from 75 to 110 GHz. Examples include automatic cruise control radar at 77 GHz, and cameras for concealed weapons detection at 94 GHz.

As noted above, a substrate 102 that is 500 microns thick will allow energy leakage for frequencies above about 60 GHz, and this would include the above noted frequencies for mmW imaging. As such, energy at the desired frequency in mmW will leak into a substrate of this thickness, thereby reducing the efficiency of the modulator 100.

It is therefore preferable to make the substrate 102 as thin as possible. However, there is no practical inexpensive commercial methodology for achieving thicknesses below about 500 microns.

### SUMMARY OF THE INVENTION

Various embodiments herein are directed to methodologies for thinning the substrate of a modulator, and a corresponding modulator produced by such methodologies.

According to an embodiment of the invention, a method for manufacturing a modulator device is provided. The method includes providing an at least partially completed modulator having a top and a bottom and a substrate; fixedly mounting the top of the modulator on a mechanical support; removing from the bottom of the modulator a portion of the substrate, thereby forming a groove in the substrate; and separating the modulator with the groove from the mechanical support; wherein the reduced thickness of the substrate in the area of the groove restricts the flow of energy leakage into the substrate.

The above method may have various features. The mounting may include applying wax, melting wax on the heated mechanical support, and placing the top of the modulator into contact with the melted wax. After the placing, pressure may be applied to the modulator relative to the mechanical support to establish a substantially parallel relationship therebetween. The separating may include removing the wax, which may include placing the support and the modulator in an acetone bath. The method may include identifying at least one target frequency for the modulator to propagate, and removing sufficient substrate such that a remaining thickness in the region of the groove is insufficient to permit leakage of energy at that target frequency into the substrate. The removing may include sawing.

According to another embodiment of the invention, a method for manufacturing a modulator device is provided. The method includes providing an at least partially completed modulator having a substrate, a waveguide imbedded in the substrate, and an electrode pattern above the substrate; fixedly mounting a top of the electrode pattern on a mechanical support; removing from a bottom of the modulator a portion of the substrate in a region in which at least a majority of the electric field would be formed in response to voltage applied to the electrode pattern, thereby forming a groove in the substrate; and separating the modulator with the groove from the mechanical support; wherein the reduced thickness of the substrate in the area of the groove restricts the flow of energy leakage into the substrate.

The above embodiment may have various features. The removing may include removing sufficient substrate such that a remaining thickness in the region of the groove is less than about 100 microns, possibly less than about 60 microns, and particularly about 39-40 microns. The method may include identifying at least one target frequency for the modulator to propagate, and the removing includes removing sufficient substrate such that a remaining thickness in the region of the groove is insufficient to permit leakage of energy at that target frequency into the substrate. The mounting may include applying wax. After the placing, the method may include applying pressure on the modulator relative to the mechanical support to establish a substantially parallel relationship therebetween. The removing may include sawing.

According to another embodiment of the invention, a method for manufacturing a modulator is provided. The method includes providing an at least partially completed modulator having a substrate, a waveguide imbedded in the substrate, and an electrode pattern above the substrate, the electrode pattern including two ground electrodes at least one other electrode therebetween; fixedly mounting a top of the electrode pattern on a mechanical support such that the modulator is inverted relative to the support; removing from the bottom of the modulator a portion of the substrate in a region at least substantially between the two ground electrodes, thereby forming a groove in the substrate; and separating the modulator with the groove from the mechanical support; wherein the reduced thickness of the substrate in the area of the groove restricts the flow of energy leakage into the substrate.

The above embodiment may have various features. The removing may include removing sufficient substrate such that a remaining thickness in the region of the groove is less than about 100 microns, possibly less than about 60 microns, and particularly about 39-40 microns. The method may include identifying at least one target frequency for the modulator to propagate, and the removing includes removing sufficient substrate such that a remaining thickness in the region of the groove is insufficient to permit leakage of energy at that target frequency into the substrate.

According to yet another embodiment of the invention, a modulator, is provided. The modulator includes a waveguide imbedded in the substrate, an electrode pattern above the substrate, the electrode pattern in including two ground electrodes at least one other electrode there between, and a groove in the substrate below the waveguide in a region at least substantially between the two ground electrodes. The reduced thickness of the substrate in the area of the groove restricts the flow of energy leakage into the substrate.

Other exemplary embodiments and advantages of the present invention may be ascertained by reviewing the present disclosure and the accompanying drawings.

### BRIEF DISCUSSION OF THE DRAWINGS

The present invention is further described in the detailed description which follows, in reference to the noted plurality of drawings by way of non-limiting examples of certain embodiments of the present invention, in which like numerals represent like elements throughout the several views of the drawings, and wherein:

FIG. 1 is a cross sectional view of a prior art electro-optical modulator.

FIG. 2 is a cross sectional view of a support according to an embodiment of the invention.

FIG. 3 is a cross sectional view of the support of FIG. 2 with a layer of wax according to an embodiment of the invention.

FIG. 4 is a cross sectional view of the wax covered support of FIG. 3 with a modulator mounted upside down thereon according to an embodiment of the invention.

FIG. 5 is cross sectional view of the configuration of FIG. 4 in proximity to a saw according to an embodiment of the invention.

FIG. 6 is a cross sectional view of the configuration of FIG. 4 after a portion of the substrate has been removed by the saw according to an embodiment of the invention.

FIG. 7 is a cross sectional view of the completed modulator according to an embodiment of the invention.

FIG. 8 is a perspective view of the embodiment of FIG. 7.

FIG. 9 is a cross sectional view of another complete modulator according to an embodiment of the invention.

FIG. 10 is a side view of an embodiment in which a modulator is immersed in a bath to separate from the support.

### DETAILED DESCRIPTION OF EMBODIMENTS OF THE INVENTION

It is to be understood that the figures and descriptions of embodiments of the present invention have been simplified to illustrate elements/steps relevant for a clear understanding of the present invention, while eliminating, for the purpose of clarity, other elements/steps found or used in typical presentations, productions, data delivery, computing systems, devices and processes. Those of ordinary skill in the art may recognize that other elements and/or steps are desirable and/or required in implementing embodiments of the present invention. However, because such elements and steps are well known in the art, and do not facilitate a better understanding of the present invention, a discussion of such elements/steps is not provided herein.

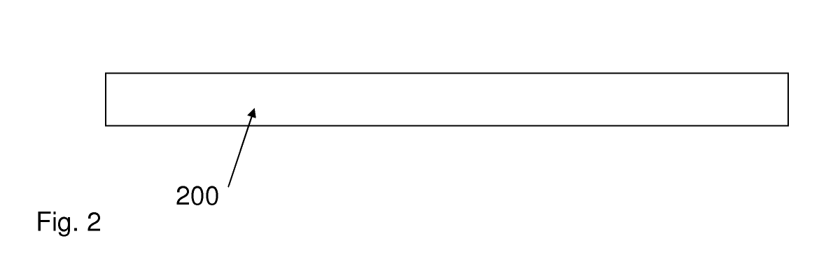

Referring now to FIG. 2, a support 200 is shown. As discussed in more detail below, support 200 will serve as a mechanical support for a modulator, such as modulator 100, during the processing as described herein. Support 200 is therefore preferably of appropriate size, shape and material to provide support for the modulator and its processing. By way of non-limiting example, support 200 may be a generally rectangular silicon wafer. Other materials, sizes and shapes may be used as appropriate. The invention is not limited to any particular type of support 200.

As discussed in more detail below, the modulator will be securely mounted on support 200. There are a variety of methods for such a mounting. By way of non-limiting example, wax can be used. However, the invention is not so limited, and other forms of mounting can be used.

If a wax method is employed, then support 200 is heated to an appropriate temperature to melt wax. A temperature of at least 80 degrees C. may be suitable, preferably 110-120 degrees C., and particularly 115 degrees C.

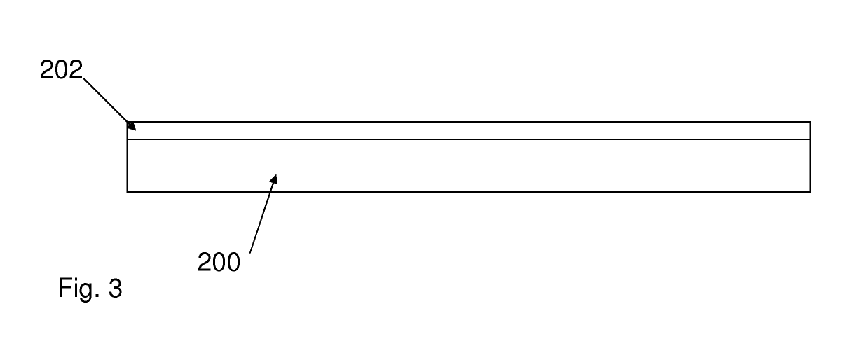

Referring now to FIG. 3, a layer of wax 202 is applied to at least the portion of support 200 that will support the modulator. After application, wax bearing support 200 may be allowed to rest to allow wax 202 to uniformly melt. The thickness of wax 202 is preferably on the order of about 20 microns, although other thickness could be used.

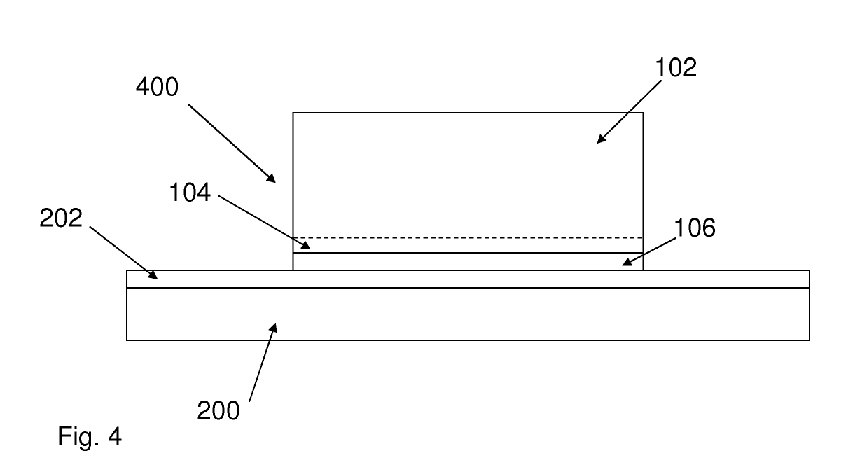

Referring now to FIG. 4, an at least partially completed modulator 400 is lowered top side down onto wax 202. Pressure may be applied to modulator 400 and/or support 200 to bring the two together to form an even seal and orient the contacting surface of modulator 400 substantially parallel with the contacting surface of support 200. Once the two components are in position, the combination is allowed to cool such that the wax can set and the two components bond. Preferably this cooling is under room temperature conditions and allows the components to return to room temperature over time, but other temperature control components (e.g., freezers) and target temperatures could be used.

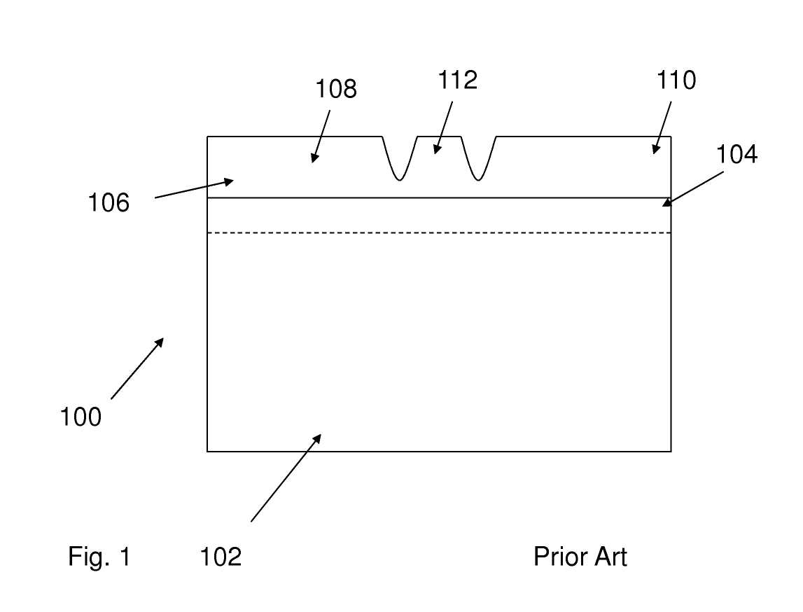

For illustration purposes only in FIG. 4, modulator 400 includes both an substrate 102, a waveguide 104 embedded in substrate 102, and an electrode region 106, but as discussed below this need not be the case at this stage of the processing. FIG. 4 does not show the specific profile of the electrode region 106, which can be viewed as an omission for ease of illustration and/or the potentially partial completed state of modulator 400. It is to be understood that modulator 400 may include completed electrode patterns as shown in FIG. 1, or other electrode patters as may be appropriate for modulators. Modulator 400 preferably is made from the same materials and has the same overall dimensions discussed with respect to modulator 100 discussed with respect to FIG. 1 above, but other sizes and materials as it appropriate to the field of modulators could be used.

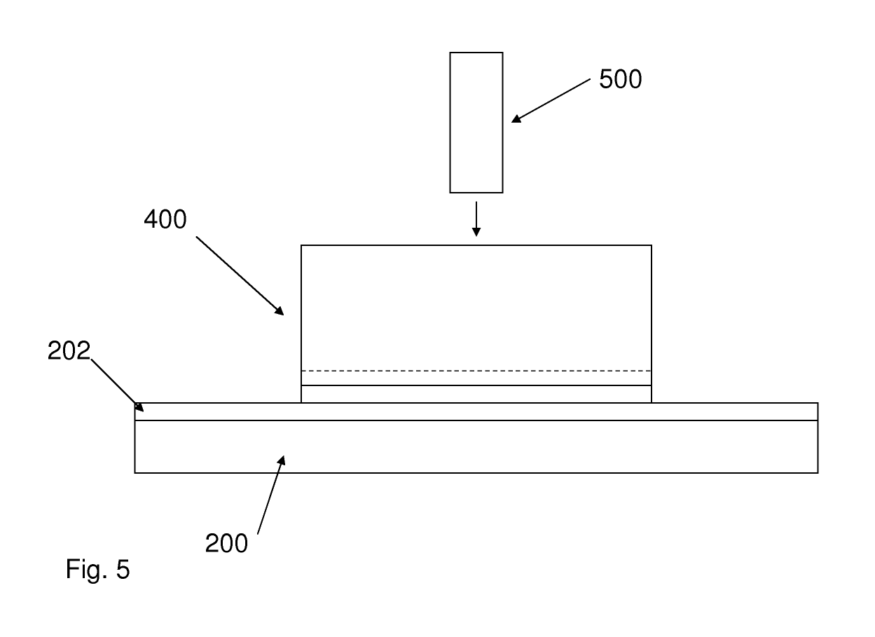

Referring now to FIG. 5, a saw 500 is brought into proximity to modulator 400. Saw 500 is preferably a dicing saw 200-400 microns in width, although other saws and/or dimensions could be used.

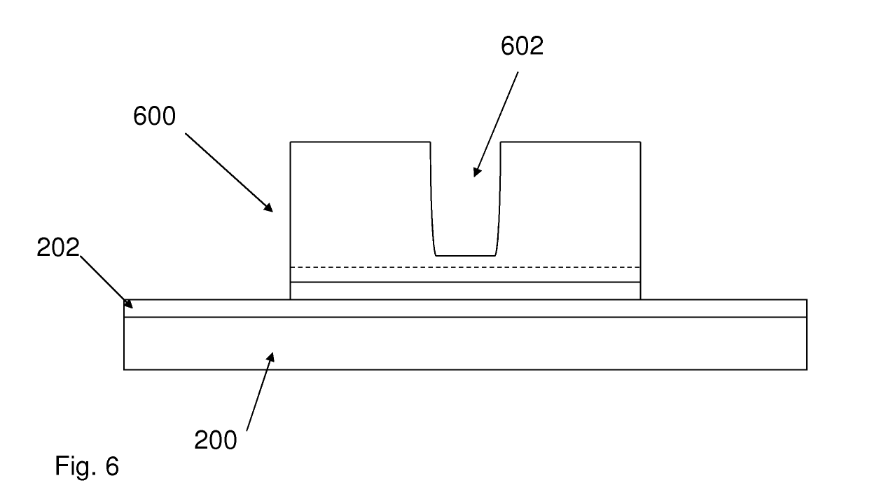

Referring now to FIG. 6, saw 500 is run along the length of modulator 400 to remove material from substrate 102 to form a groove 602. As discussed in more detail below, this alters that nature of the modulator, such that the modulator 400 as now altered via the groove 602 is herein referred to as modulator 600.

At a minimum, a single pass of saw 500 will create a groove 602 that may be sufficient if the width of the saw is large enough relative to the desired size of the groove. However, the invention is not so limited, and multiple passes could be used. In theory only a single groove is created, but again multiple grooves (not shown) could be present.

Optionally, modulator 600 could be subject to further “finishing” level processing. For example, groove 602 could be polished or cleaned. Some or all of groove 602 could be filed with another material to provide additional overall structural stability.

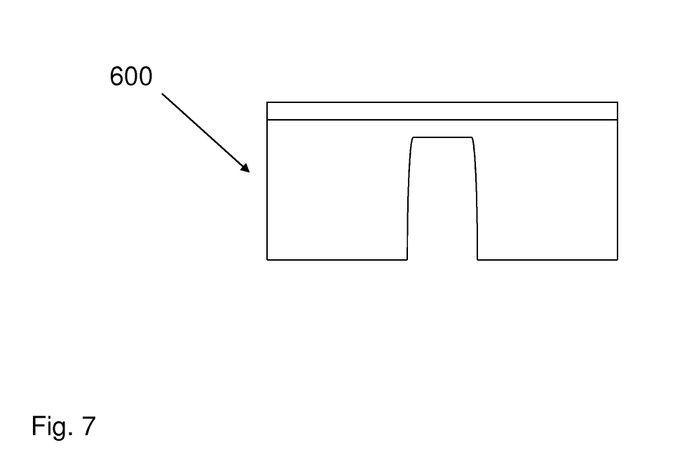

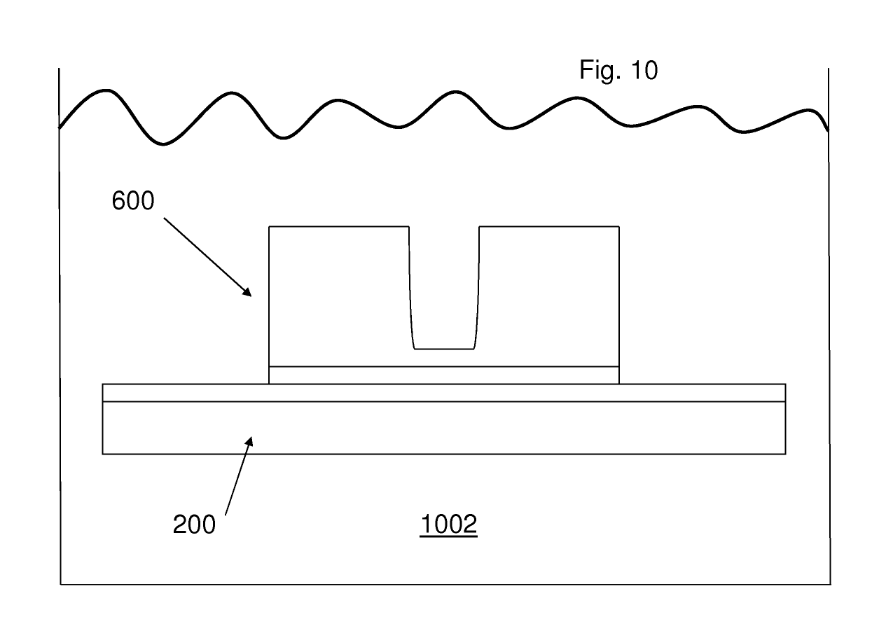

Referring now to FIG. 7, modulator 600 is separated from support 200 and returned to its upright position. The nature of the separation methodology is based on the nature of the initial bonding. For a wax based bonding, any separation methodology that removes the wax is appropriate. By way of non-limiting example, support 200 and modulator 400 could be lowered into an acetone bath 1002 such as shown in FIG. 10.

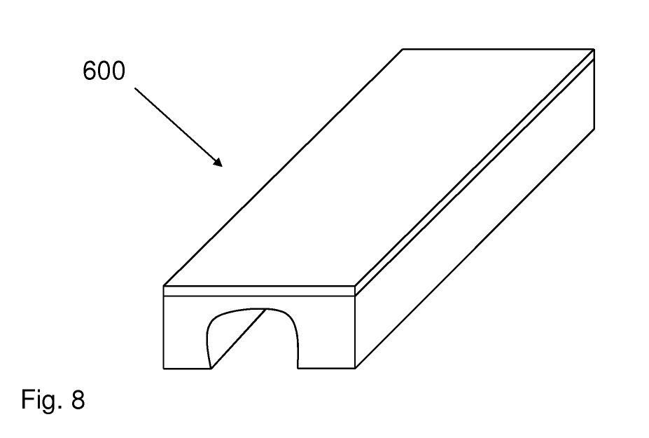

A perspective view showing the groove 602 along the length of modulator 600 is shown in FIG. 8. Although the groove is shown as uniform along the length of modulator 600, the invention is not so limited, and there may be breaks along the pathway.

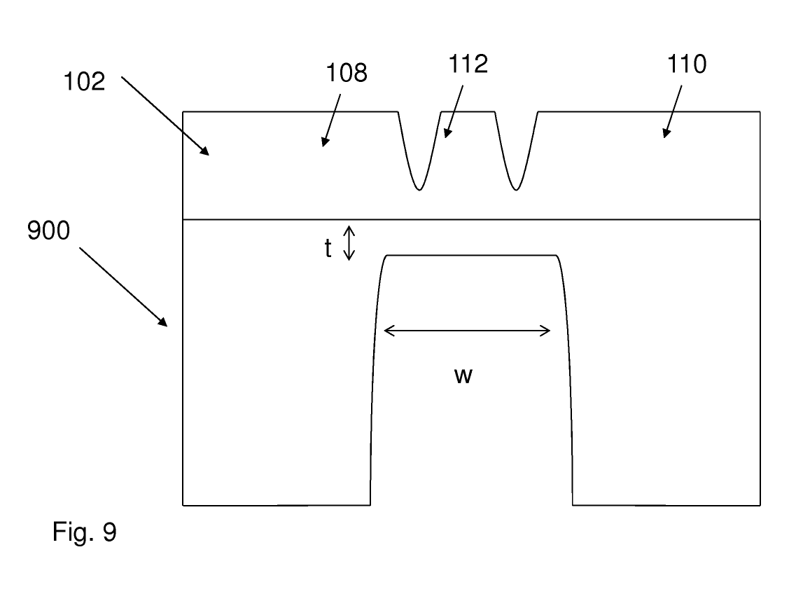

Referring now to FIG. 9, a modulator 900 having a specific electrode configuration 106 (the same as in FIG. 1) is shown. While a modulator is not limited to the configuration of FIG. 9, it does for purposes of explanation illustrate various non-limiting preferences on the location and dimensions of the groove 602.

As to the general location, the groove 602 should be below the portion of the electrode region 106 that generates the electric field under applied voltage. Groove 602 should also be wide enough to extend over a majority of the applied electric field. In the embodiment of FIG. 9, some 99% of the field is between the two ground electrodes 108 and 110, such that the width of groove 602 at a minimum should approach, if not extend beyond, those ground electrodes. However, the invention is not so limited, and other widths and locations may be used. The groove may or not be generally centered below the center electrode 112.

The depth of the groove 602 and the corresponding thickness t of remaining substrate 102 in the region may be driven by design considerations and practical limits. On the one hand, almost all of the substrate 102 can be removed, leaving on the order of 15 microns in thickness. This would translate to a massive increase in the threshold of the substrate leakage frequency to on the order of 800 GHz, although as a practical matter such a small dimension may threaten overall structural integrity. On the other hand, even minimal reductions in thickness—e.g., removing on the order of 10 microns thickness of substrate 102—will marginally increase the threshold frequency of the substrate leakage, and potentially improve performance if this threshold increases beyond the frequency of the signal of interest. Both extremes fall within the scope of the invention.

Preferably at the very least the depth of the groove 602 should leave a remaining thickness t that is sufficient to raise the threshold for leakage to above the wavelengths for the signals of interest propagating through modulator 104. Thus for example, automatic cruise control radar at 77 GHz may experience leakage in a modulator with a 500 micron thick substrate, but not at a thickness t of about 350 microns. Cameras for concealed weapons detection at 94 GHz may experience leakage in a modulator with a 350 micron thick substrate, but not at a thickness t of about 250 microns. Once the frequency of the data signal is known, modulator 602 can be designed with groove 602 to a depth that simply will not allow energy at that frequency to leak into substrate 102. If data is being sent at multiple frequencies, preferably the depth of groove 602 is set above the highest frequency, which will thereby prevent leakage from any of the frequencies.

The modulator 600 can thus be customer designed with a groove based on the signal of use for the intended interest. In the alternative, it may be preferable to have a general commercial modulator with a low frequency threshold that can be used in without prior knowledge of the signal of interest. For such general use, preferably the thickness t of the remaining substrate 102 is less than about 100 microns, particularly less than 60 microns, and most particularly at about 39-40 microns. Thickness on the order of about 39-40 microns will raise the frequency threshold for leakage to about 300 GHz. For mmW applications in the 75-110 GHz range, this effectively eliminates any energy leakage at frequencies of signals of interest. The invention is not limited to any depth and/or resulting improvement in leakage as discussed herein.

Embodiments herein apply to environments discussed in “Development and Characterization of LiNbO3 Electro-Optic Phase Modulator at 220 GHz for Millimeter-Wave Imaging System,” and U.S. patent application entitled MILLIMETER-WAVE ELECTRO-OPTIC MODULATOR (noted above), both of which are incorporated by reference herein in their entireties.

The methodologies described herein allow the realization of very high speed LN-based electro-optic modulators operating in W-band and above by reducing or eliminating substrate modes that otherwise limit the bandwidth of those types of devices. This method improves the bandwidth of any modulator designed to work in W-band and above. Technically, it minimizes or eliminates the coupling of the electrical field applied to the modulator with the substrate modes by reducing the thickness of the substrate in such a way that those modes are not supported anymore. The efficiency of such a device can be increased by a factor of two in W-band using this technique relative to modulator 100, with bandwidth also increased by two with modulation up to 220 GHz.

Various embodiments have been discussed with respect to electro-optical modulators. However, the invention is not so limited. The methodologies herein may be applied to other types of modulators as well.

Various embodiment herein have been discussed with respect to mounted a completed (at least in the sense of the prior art) modulator 100 onto support 200 for processing as described herein; in other words, the embodiments herein represent a post-processing of an otherwise complete modulator. However, the invention is not so limited. The material mounted on support 200 could be a partially completed modulator, and the modulator could be completed after the substrate is thinned; in other words, the embodiments herein may represent a mid-processing step rather than a post processing step. By way of non-limiting example, a partially complete modulator with the substrate 102 but not the electrode 106; the electrode could be added after the substrate is thinned. The invention is not limited to when in the process the substrate is thinned.

Various embodiments herein are discussed with reference to a single modulator and a single support. However, the invention is not so limited. The methodologies herein can be scaled to include multiple modulators and/or multiple supports.

It will be apparent to those skilled in the art that modifications and variations may be made in the systems and methods of the present invention without departing from the spirit or scope of the invention. It is intended that the present invention cover the modifications and variations of this invention provided they come within the scope of the appended claims and their equivalents.

What is claimed:

1. A method for manufacturing a modulator device, comprising:
providing an at least partially completed modulator having a top and a bottom and a substrate;
fixedly mounting the top of the modulator on a mechanical support;
removing from the bottom of the modulator a portion of the substrate, thereby forming a groove in the substrate; and
separating the modulator with the groove from the mechanical support;
wherein the reduced thickness of the substrate in the area of the groove restricts the flow of energy leakage into the substrate.

2. The method of claim 1, wherein the mounting comprises applying wax.

3. The method of claim 1, wherein the mounting comprises:
melting wax on the heated mechanical support; and
placing the top of the modulator into contact with the melted wax.

4. The method of claim 3, further comprising, after the placing, applying pressure on the modulator relative to the mechanical support to establish a substantially parallel relationship therebetween.

5. The method of claim 2, wherein the separating comprises removing the wax.

6. The method of claim 5 wherein the separating comprises placing the support and the modulator in an acetone bath.

7. The method of claim 1, further comprising:
identifying at least one target frequency for the modulator to propagate; and
the removing comprises removing sufficient substrate such that a remaining thickness in the region of the groove is insufficient to permit leakage of energy at that target frequency into the substrate.

8. The method of claim 1, wherein the removing comprises sawing.

9. A method for manufacturing a modulator device, comprising:
providing an at least partially completed modulator having a substrate, a waveguide imbedded in the substrate, and an electrode pattern above the substrate;
fixedly mounting a top of the electrode pattern on a mechanical support;
removing from a bottom of the modulator a portion of the substrate in a region in which at least a majority of the electric field would be formed in response to voltage applied to the electrode pattern, thereby forming a groove in the substrate; and
separating the modulator with the groove from the mechanical support;
wherein the reduced thickness of the substrate in the area of the groove restricts the flow of energy leakage into the substrate.

10. The method of claim 9, wherein the removing comprises removing sufficient substrate such that a remaining thickness in the region of the groove is less than about 100 microns.

11. The method of claim 9, wherein the removing comprises removing sufficient substrate such that a remaining thickness in the region of the groove is less than about 60 microns.

12. The method of claim 9, wherein the removing comprises removing sufficient substrate such that a remaining thickness in the region of the groove is about 39-40 microns.

13. The method of claim 9, further comprising:
identifying at least one target frequency for the modulator to propagate;
the removing comprises removing sufficient substrate such that a remaining thickness in the region of the groove is insufficient to permit leakage of energy at that target frequency into the substrate.

14. The method of claim 9, wherein the mounting comprises applying wax.

15. The method of claim 9, further comprising, after the placing, applying pressure on the modulator relative to the mechanical support to establish a substantially parallel relationship therebetween.

16. The method of claim 9, wherein the removing comprises sawing.

17. A method for manufacturing a modulator device, comprising:
providing an at least partially completed modulator having a substrate, a waveguide imbedded in the substrate, and an electrode pattern above the substrate, the electrode pattern including two ground electrodes at least one other electrode therebetween;
fixedly mounting a top of the electrode pattern on a mechanical support such that the modulator is inverted relative to the support;
removing from the bottom of the modulator a portion of the substrate in a region at least substantially between the two ground electrodes, thereby forming a groove in the substrate; and
separating the modulator with the groove from the mechanical support;
wherein the reduced thickness of the substrate in the area of the groove restricts the flow of energy leakage into the substrate.

18. The method of claim 17, wherein the removing comprises removing sufficient substrate such that a remaining thickness in the region of the groove is less than about 100 microns.

19. The method of claim 17, wherein the removing comprises removing sufficient substrate such that a remaining thickness in the region of the groove is less than about 60 microns.

20. The method of claim 17, wherein the removing comprises removing sufficient substrate such that a remaining thickness in the region of the groove is about 39-40 microns.

21. The method of claim 16, further comprising:
identifying at least one target frequency for the modulator to propagate;
the removing comprises removing sufficient substrate such that a remaining thickness in the region of the groove is insufficient to permit leakage of energy at that target frequency into the substrate.

22. A modulator, comprising:
a substrate;
a waveguide imbedded in the substrate;
an electrode pattern above the substrate, the electrode pattern in including two ground electrodes at least one other electrode there between; and
a groove in the substrate below the waveguide in a region at least substantially between the two ground electrodes;
wherein the reduced thickness of the substrate in the area of the groove restricts the flow of energy leakage into the substrate.
